(19) United States
(12) Patent Application Publication
(10) Pub. No.: US 2026/0212268 A1
(43) Pub. Date: Jul. 23, 2026

(54) FEDERATED LEARNING SYSTEM, FEDERATED LEARNING SERVER, AND FEDERATED LEARNING CLIENT

(71) Applicant: Toshiba Tec Kabushiki Kaisha, Tokyo (JP)

(72) Inventor: Hiroshi IWASAKI, Susono Shizuoka (JP)

(21) Appl. No.: 19/387,169

(22) Filed: Nov. 12, 2025

(30) Foreign Application Priority Data
Jan. 20, 2025 (JP) 2025-007954

(51) Int. Cl. G06N 20/00

(52) U.S. Cl. CPC G06N 20/00

(57) ABSTRACT

According to one embodiment, a federated learning system includes a federated learning server storing a client ID database and federated learning client setup information. The system also includes federated learning clients connected to the server. The server is configured to receive a setup inquiry from a federated learning client, search the client ID database to confirm a client ID included in the setup inquiry is in the client ID database, send a setup inquiry response to the client when the client ID included in the setup inquiry is in the client ID database, and send the federated learning client setup information to the client after the client ID included in the setup inquiry is confirmed. The federated learning client is configured to receive the federated learning client setup information from the server and execute a federated learning client setup according to the received setup information.

### CROSS-REFERENCE TO RELATED APPLICATION

This application is based upon and claims the benefit of priority from Japanese Patent Application No. 2025-007954, filed January 20, 2025, the entire contents of which are incorporated herein by reference.

### FIELD

Embodiments described herein relate generally to a federated learning system incorporating a federated learning server and a federated learning client.

### BACKGROUND

Machine learning is a technique in which various pieces of training data are aggregated, then an artificial intelligence (AI) machine learning model is trained to perform inferences based on the aggregated training data. However, when large-volume data, such as images, videos, or sound files, is used as the training data, a high-speed and large-capacity communication network is required to collect the training data for aggregation. In addition, a large-capacity storage system is required to store this collected training data. When personal information such as facial images is included in the training data, there is a concern that privacy cannot be protected since the personal information must generally be transmitted over a communication network in the collecting process.

In view of such issues, in recent years, a distributed machine learning method called federated learning has been proposed. In federated learning, computers that perform the machine learning (training) are provided at the sites where the training data is generated. These site-distributed computers may be connected to a system server via respective dedicated communication networks or the like. Thus, each computer separately trains a machine learning model based on the training data generated at the site, and then transmits the results to the server. The server then aggregates the learning (training) results from the different computers to create a comprehensive (aggregated) machine learning model, which may then be transmitted to the site-distributed computers or the like for local use. Each such computer may then perform inference processing based on the comprehensive machine learning model received from the server.

In federated learning, each site-distributed computer locally performs the machine learning using training data acquired independently, and thus it is not necessary to aggregate all training data in one computer. Therefore, a large-capacity communication network and storage is not required. Since the local training data is not transmitted to a central location for aggregation, there is no concern about leakage of the personal information, and privacy can be protected.

However, in order to construct a federated learning system, it is necessary to set up each of the local computers for the learning process by installing a dedicated program for providing the federated learning functions so the computers can perform the machine learning at the respective sites where training data is being generated. When such setup work must be manually performed, the larger the number of sites and the greater the physical distance between sites, the more labor and time that will be consumed.

### BRIEF DESCRIPTION OF THE DRAWINGS

FIG. 1 is a schematic diagram illustrating a federated learning system.

FIG. 2 is a diagram related to setup according to a first embodiment.

FIG. 3 illustrates an example of data stored in a storage database.

FIG. 4 is a block diagram illustrating a functional configuration of a federated learning server and federated learning clients.

FIG. 5 is a flowchart illustrating an operation procedure of a federated learning server executed according to a server-side setup program.

FIG. 6 is a flowchart illustrating an operation procedure of a federated learning client executed according to a client-side setup program.

FIG. 7 is a sequence diagram of data signals exchanged among a control computer, a federated learning server, and a federated learning client.

FIG. 8 is a block diagram illustrating a functional configuration according to a second embodiment.

FIG. 9 is a sequence diagram of data signals.

FIG. 10 illustrates an example of data according to a third embodiment.

FIG. 11 is a sequence diagram of data signals.

FIG. 12 is a diagram related to setup according to a fourth embodiment.

FIG. 13 illustrates an example of data.

FIG. 14 is a block diagram illustrating a functional configuration.

FIG. 15 is a sequence diagram of data signals exchanged among a control computer, a federated learning server, a federated learning client, and a container registry.

### DETAILED DESCRIPTION

Embodiments address issues and problems found in the setting up of federated learning systems. Embodiments represent technological solutions to improve the efficiency in performing the initial setup and construction of a federated learning system.

In general, according to one embodiment, a federated system includes a federated learning server storing a client ID database and federated client setup information. The system further includes a plurality of federated learning clients communicably connected to the federated learning server. The federated learning server is configured to: receive a setup inquiry from a federated learning client in the plurality of federated learning clients; search the client ID database to confirm a client ID included in the setup inquiry is in the client ID database; send a setup inquiry response to the federated learning client when the client ID included in the setup inquiry is confirmed as being in the client ID database; and send the federated learning client setup information to the federated learning client after the client ID included in the setup inquiry is confirmed as being in the client ID database. The federated learning client is configured to receive the federated learning client setup information from the federated learning server and execute a federated learning client setup based on the received federated learning client setup information.

Hereinafter, certain example embodiments in which setup for constructing a federated learning system is efficiently performed will be described with reference to the drawings.

### Overview of a Federated Learning System

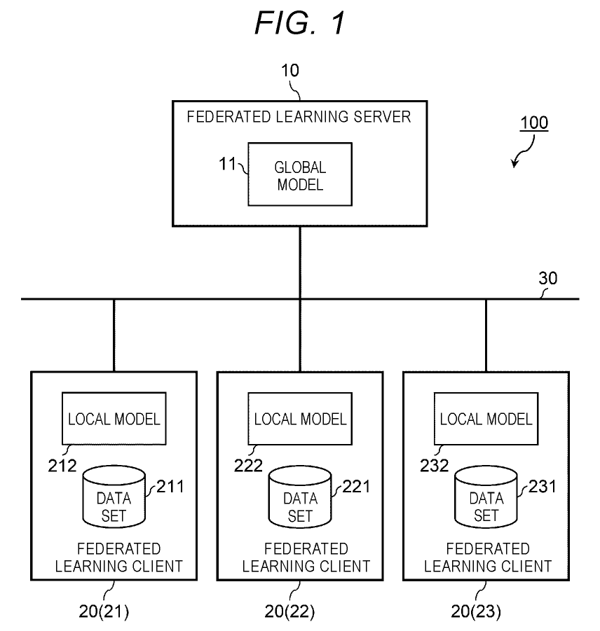

FIG. 1 is a schematic diagram illustrating a federated learning system 100. The federated learning system 100 includes one federated learning server 10 and a plurality of federated learning clients 20 (individual federated learning clients 21, 22, and 23 are each a federated learning client 20 and collectively representative of a plurality of federated learning clients 20). The federated learning server 10 and the federated learning clients 21, 22, and 23 are connected via a communication network 30 in the federated learning system 100. The communication network 30 can be a wide area network such as the Internet or an intranet. A mobile communication network, a public communication network, or the like may be used as a part of the communication network 30.

For convenience of explanation, when description is the same for each of the federated learning clients 20 (21, 22, and 23) they may be referred to as federated learning clients 20. When aspects that are distinct, individual, or particularized to a particular federated learning client 20 are being described, the particular federated learning client 20 may be referred to as one of the federated learning client 21, the federated learning client 22, or the federated learning client 23. The total number of the federated learning clients 20 is not limited to three. The federated learning system 100 may have just two federated learning clients 20, or four or more federated learning clients 20.

In this example, federated learning clients 20 are computers that are provided at the respective sites where training data is generated. Each respective federated learning client 20 performs inference by training respective (local) machine learning models using the training data generated at the respective sites. The training data is, for example, data of an image or a video captured by a camera. For example, when purchase behavior is to be predicted by machine learning, the training data includes data (information) about purchased commodities registered at a Point of Sales (POS) terminal and data related to, or indicating, a customer category (type) of the corresponding purchaser, or the like. However, the types of training data are not particularly limited.

Each federated learning client 20 includes a data set and a local model. In particular, the federated learning client 21 includes a data set 211 and a local model 212, the federated learning client 22 includes a data set 221 and a local model 222, and the federated learning client 23 includes a data set 231 and a local model 232. The federated learning client 21 performs inference training using the training data aggregated in the data set 211 and the local model 212 (a machine learning model). The federated learning client 22 performs inference training using the training data aggregated in the data set 221 and the local model 222 (a machine learning model). The federated learning client 23 performs inference training using the training data aggregated in the data set 231 and the local model 232 (a machine learning model).

In general, the federated learning client 20 performs the machine learning using a software library such as Scikit-Learn, TensorFlow®, or PyTorch as a framework. The federated learning client 20 transmits parameter data obtained by the machine learning to the federated learning server 10 via the communication network 30. In some cases, when a higher-performance computer is required due the type of training data to be handled, the amount of training data, the size of the machine learning model, or the like, a computing resource provided by a cloud service provider may be used as the federated learning client 20.

The federated learning server 10 integrates model parameter data or the like received from each of the federated learning clients 20. That is, the model parameter data that is a result of the local machine learning performed by each federated learning client 20 is combined to create a comprehensive machine learning model, which is referred to as global model 11 in this context. The federated learning server 10 ultimately distributes the global model 11 to the federated learning clients 20 via the communication network 30. The federated learning client 20 can then perform inference processing or the like using the global model 11 that is based on, or utilizes, the integrated model parameter data. The federated learning server 10 may provide service in on-premises environment or in a cloud computing environment.

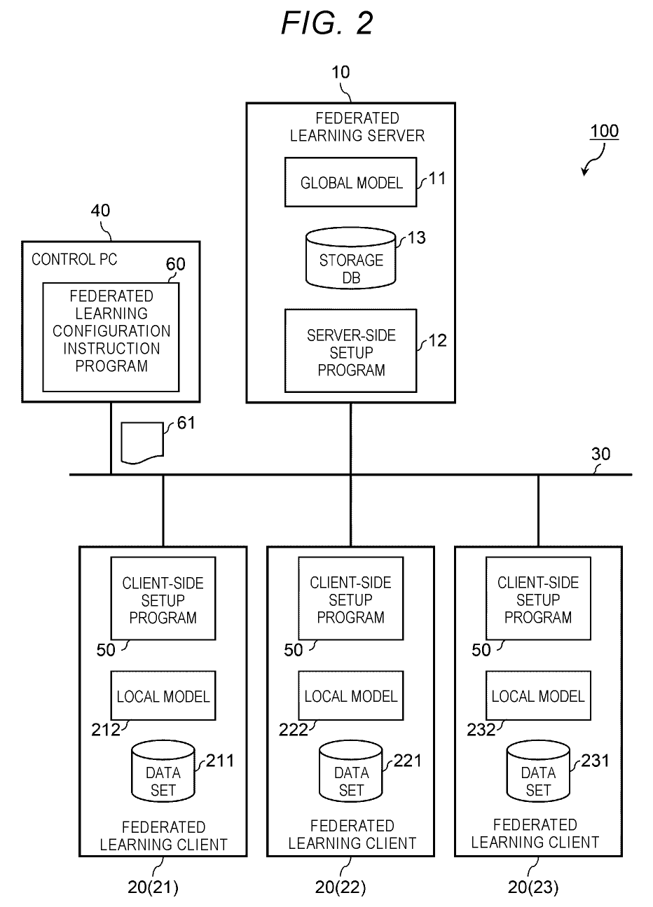

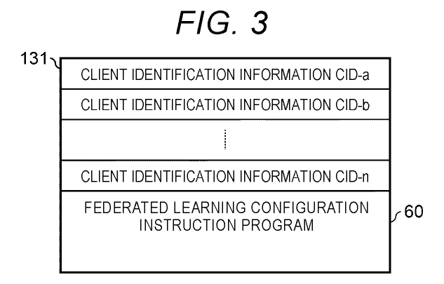

When constructing such a federated learning system 100, the federated learning client 20 can use a framework in which federated learning is performed, for example, OpenFL or Flower, that is separate from the software library such as Scikit-Learn, TensorFlow® (or PyTorch described above. This type of framework is a so-called federated learning framework that supports implementation of federated learning, and does not directly have a function related to training or inference processing of a machine learning model. Therefore, the federated learning client 20 requires a program for calling the parameter data, which is the result of the machine learning, into the federated learning framework. Hereinafter, this program is referred to as a federated learning configuration instruction program 60 (see FIGS. 2 or 3). The federated learning system 100 is set up by implementing the federated learning configuration instruction program 60 for each federated learning client 20. The federated learning configuration instruction program 60 is an example of setup data in this context. An embodiment related to the setup of the federated learning system 100 will be described.

### First Embodiment

FIG. 2 is a diagram related to the setup of the federated learning system 100 according to the first embodiment. In the first embodiment, in order to set up the federated learning system 100, a server-side setup program 12 is stored in the federated learning server 10. Client-side setup programs 50 are stored in the federated learning clients 21, 22, and 23, respectively. The server-side setup program 12 and the client-side setup program 50 are both agent programs and are resident in the federated learning server 10 and the federated learning clients 21, 22, and 23, respectively.

In the first embodiment, a storage database 13 is in the federated learning server 10. The storage database 13 functions as a storage portion in which setup data is stored. The storage database 13 may in the federated learning server 10 or in a storage device or the like externally attached to the federated learning server 10. Alternatively, the storage database 13 may be stored in another server accessible by the federated learning server 10 via the communication network 30.

FIG. 3 is an example of data 131 stored in the storage database 13. As illustrated, the data 131 includes a plurality of pieces of client identification information CID and a federated learning configuration instruction program 60 as setup data. The client identification information CID is individual identification information of a computer that operates as a federated learning client 20. For example, identification information unique to a computer, such as a production number of the computer, a MAC address of a network card attached to the computer, or an identification number assigned to the computer by an asset management system or the like, can be used as the individual identification information (client identification information CID).

In present description it may be assumed federated learning client 21 is provided at a site A, federated learning client 22 is provided at a site B, and federated learning client 23 is provided at a site C.

Here, the storage database 13 stores client identification information CID-a of the computer serving as the federated learning client 21, client identification information CID-b of the computer serving as the federated learning client 22, and client identification information CID-c of the computer serving as the federated learning client 23.

As described above, a federated learning system 100 capable of identifying any individual site where a federated learning client 20 is provided can be constructed by appropriately changing the client identification information stored in the storage database 13.

What client identification information CID is stored in the storage database 13 is controlled by a control computer 40 (control PC) connected to the communication network 30. The control computer 40 includes the federated learning configuration instruction program 60. The federated learning configuration instruction program 60 may be created by the control computer 40 or may be created by another computer and then stored in the control computer 40.

The control computer 40 receives an instruction from an operator and, in response to the instruction, generates a data file 61 for storing data to be stored in the storage database 13. The data is the federated learning configuration instruction program 60 and two or more pieces of client identification information CID. The control computer 40 transmits the data file 61 to the federated learning server 10 via the communication network 30. The federated learning server 10 receives the data file 61 and overwrites (if necessary) and stores the received data file 61, or the information therein, in the storage database 13.

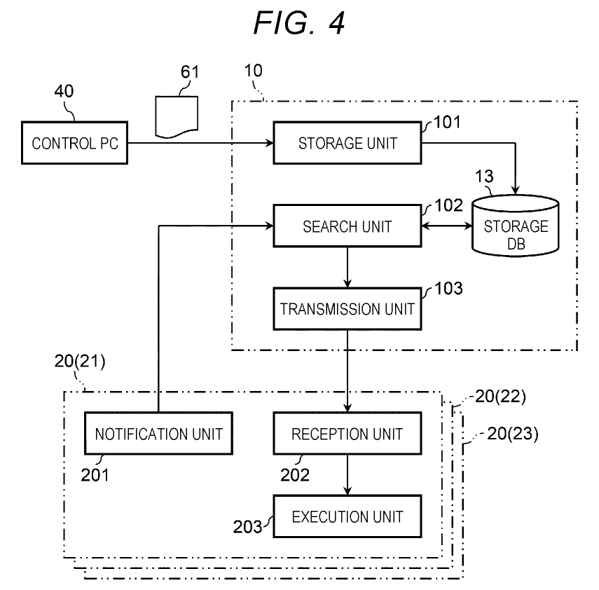

FIG. 4 is a block diagram illustrating a functional configuration of the federated learning server 10 and the federated learning clients 20 at setup of the federated learning system 100. The federated learning server 10 provides, by processing executed by a processor or the like, a storage unit 101, a search unit 102, and a transmission unit 103 as functions related to the setup of the federated learning system 100.

The storage unit 101 stores the client identification information CID of a federated learning client and setup data for setting up a computer as the federated learning client in a storage portion. In this context, the setup data is the federated learning configuration instruction program 60. The storage portion is a part of the storage database 13. That is, when the storage unit 101 receives the data file 61 generated by the control computer 40 via the communication network 30, the storage unit 101 stores the pieces of client identification information CID and the federated learning configuration instruction program 60 of the received data file 61 in the storage database 1.

The search unit 102 searches the storage database 13 to check whether client identification information CID sent from a federated learning client 20 is already stored in the storage database 13. Each federated learning client 20 includes a notification unit 201 that notifies the federated learning server 10 of its respective client identification information CID. Upon receiving a client identification information CID notification from any one of the federated learning clients 21, 22, and 23, the search unit 102 searches the storage database 13 to determine whether the client identification information CID in the notification is stored in the storage database 13.

The transmission unit 103 transmits the setup data to the federated learning client 20 identified by the client identification information CID stored in the storage portion. That is, the transmission unit 103 transmits the federated learning configuration instruction program 60 to a federated learning client 20 identified by the client identification information CID stored in the storage database 13.

For example, if the search unit 102 determines that the client identification information CID-a obtained in a notification from the federated learning client 21 is stored in the storage database 13, the transmission unit 103 transmits the federated learning configuration instruction program 60 to the federated learning client 21. If the search unit 102 determines that the client identification information CID-b obtained in a notification from the federated learning client 22 is stored in the storage database 13, the transmission unit 103 transmits the federated learning configuration instruction program 60 to the federated learning client 22. If the search unit 102 determines that the client identification information CID-c obtained in a notification from the federated learning client 23 is stored in the storage database 13, the transmission unit 103 transmits the federated learning configuration instruction program 60 to the federated learning client 23.

Each federated learning client 20 provides, as processing executed by a processor or the like, a notification unit 201, a reception unit 202, and an execution unit 203 as functions related to the setup of the federated learning system 100.

The notification unit 201 has a function of notifying the federated learning server 10 of the client identification information CID of the respective federated learning client 20. The notification unit 201 transmits, to the federated learning server 10 via the communication network 30, the client identification information CID such as a production number set for a computer, the MAC address of a network card, or an identification number assigned by an asset management system or the like. The notification unit 201 includes a communication address of the federated learning server 10 and transmits the client identification information CID to the communication address.

The reception unit 202 has a function of receiving the setup data from the federated learning server 10. That is, the reception unit 202 receives the federated learning configuration instruction program 60 transmitted via the communication network 30 to the communication address of the federated learning client 20. For example, the reception unit 202 of the federated learning client 21 receives the federated learning configuration instruction program 60 with a communication address of the federated learning client 21 as a destination.

The execution unit 203 has a function of executing the setup based on the setup data received by the reception unit 202. That is, the execution unit 203 installs and executes the federated learning configuration instruction program 60 received by the reception unit 202. By executing the federated learning configuration instruction program 60, the federated learning client 20 is set up as a client in the federated learning system 100. For example, when the execution unit 203 of the federated learning client 21 executes the federated learning configuration instruction program 60, the federated learning client 21 is set up as a client in the federated learning system 100.

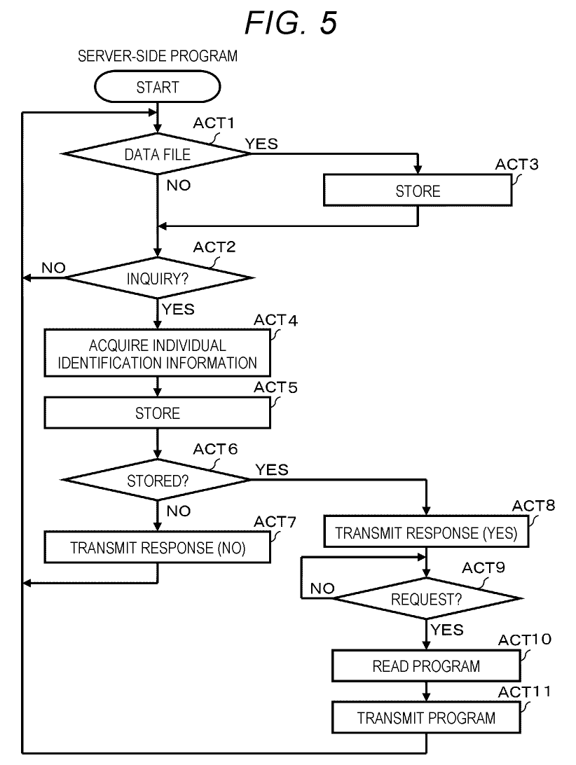

In the federated learning server 10, the functions of the storage unit 101, the search unit 102, and the transmission unit 103 are implemented by execution of the server-side setup program 12. In the federated learning client 20, the functions of the notification unit 201, the reception unit 202, and the execution unit 203 are implemented by execution of the client-side setup program 50. Next, certain aspects of the operations executed according to the server-side setup program 12 on the federated learning server 10 and according to the client-side setup program 50 on a federated learning client 20 will be described with reference to FIGS. 5 to 7.

The method of installing the server-side setup program 12 in the federated learning server 10 is not particularly limited. The server-side setup program 12 can be installed in the federated learning server 10 by recording the server-side setup program 12 in a removable recording medium or distributing the server-side setup program 12 via the communication network 30. The recording medium may be in any form, such as a CD-ROM or a memory card, as long as the recording medium can store a program and be read by a computer device or the like.

Similarly, the method of installing the client-side setup program 50 in the federated learning client 20 is not particularly limited. The client-side setup program 50 can be installed in the federated learning client 20 by recording the client-side setup program 50 in a removable recording medium or distributing the client-side setup program 50 via the communication network 30. The recording medium may be in any form, such as a CD-ROM or a memory card, as long as the recording medium can store a program and can be read by a computer device or the like.

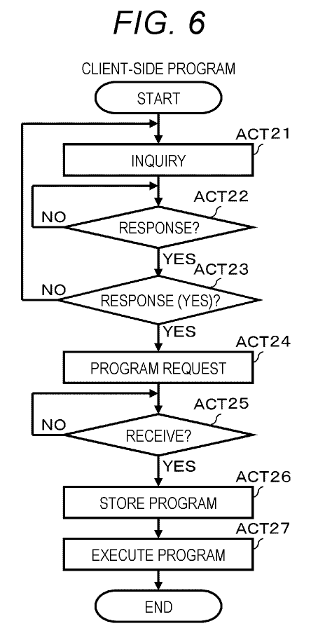

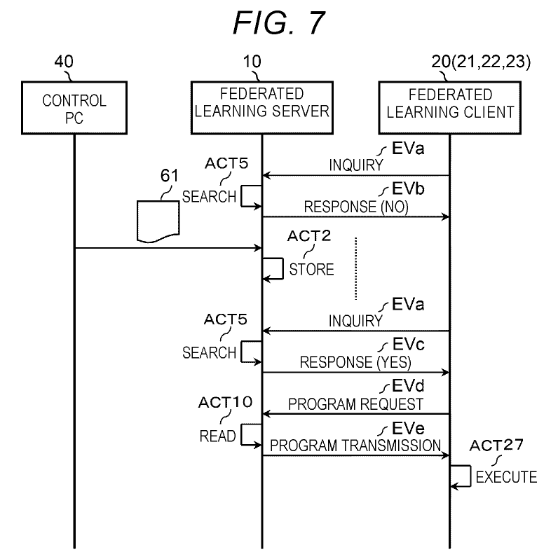

FIG. 5 is a flowchart illustrating the operation procedure executed according to the server-side setup program 12 by the federated learning server 10. FIG. 6 is a flowchart illustrating the operation procedure executed according to the client-side setup program 50 by the federated learning client 20. FIG. 7 is a sequence diagram of data signals exchanged among the control computer 40, the federated learning server 10, and the federated learning client 20.

As illustrated in FIG. 5, the federated learning server 10 checks whether a data file 61 is received in ACT1. If the data file 61 is not received, the federated learning server 10 proceeds to ACT2. The federated learning server 10 checks whether an inquiry event EVa is received in ACT2. An inquiry event EVa is periodically transmitted from the federated learning client 20. The inquiry event EVa includes the individual identification information of the transmission source computer, that is, the client identification information CID of the enquiring federated learning client 20. If the inquiry event EVa is not received, the federated learning server 10 returns to ACT1. As described above, the federated learning server 10 waits to receive the data file 61 or the inquiry event EVa in ACT1 or ACT2.

If the data file 61 is received in the waiting state, the federated learning server 10 proceeds to ACT3. The federated learning server 10 acquires the federated learning configuration instruction program 60 and the pieces of client identification information CID from the data file 61, and stores the federated learning configuration instruction program 60 and the pieces of client identification information CID in the storage database 13. Thereafter, the federated learning server 10 returns to the waiting state (ACT1 and ACT2).

If an inquiry event EVa transmitted from any one of the federated learning clients 20 is received in the waiting state, the federated learning server 10 proceeds to ACT4. The federated learning server 10 acquires the client identification information CID from the inquiry event EVa in ACT4.

The federated learning server 10 searches the storage database 13 in ACT5. The federated learning server 10 checks whether the client identification information CID acquired from the inquiry event EVa is stored in the storage database 13 in ACT6. If the corresponding client identification information CID is not in the storage database 13, the federated learning server 10 proceeds to ACT7. The federated learning server 10 transmits a response indicating that the client identification information CID is not stored, that is, a response (no) event EVb is sent to the inquiry source in ACT7. Thereafter, the federated learning server 10 returns to the waiting state of ACT1 and ACT2.

In contrast, if the client identification information CID acquired from the inquiry event EVa is found to be stored in the storage database 13 in ACT6, the federated learning server 10 proceeds to ACT8. The federated learning server 10 transmits a response indicating that the client identification information CID is stored, that is, a response (yes) event EVc is sent to the inquiry source in ACT8. Then, the federated learning server 10 waits for a program request event EVd in ACT9.

If the federated learning client 20 receives a response (yes) event EVc, it then transmits a program request event EVd to the federated learning server 10. When the federated learning server 10 receives the program request event EVd, the federated learning server 10 proceeds to ACT10. The federated learning server 10 reads the federated learning configuration instruction program 60 from the storage database 13 in ACT10. Then, the federated learning server 10 transmits a program transmission event EVe to the program request source in ACT11. The program transmission event EVe includes the federated learning configuration instruction program 60 as read from the storage database 13. The federated learning server 10 then returns to the waiting state of ACT1 and ACT2.

As described above, when the federated learning server 10 receives a data file 61 from the control computer 40 (YES in ACT1), the federated learning server 10 stores, in the storage database 13, the federated learning configuration instruction program 60 and the client identification information CID included in the data file 61 (ACT3). Here, the federated learning server 10 implements the function of the storage unit 101 by the processing in ACT3.

Every time the federated learning server 10 receives an inquiry event Eva, which is periodically transmitted from the federated learning clients 20 (YES in ACT2), the federated learning server 10 searches the storage database 13 (ACT5). If the client identification information CID included in the inquiry event EVa is stored in the storage database 13 (YES in ACT6), the federated learning configuration instruction program 60 is read from the storage database 13 (ACT10) and transmitted to the inquiry source, that is, the federated learning client 20 that sent the inquiry (ACT11). Here, the federated learning server 10 implements the function of the search unit 102 by the processing in ACT5 and ACT6. The federated learning server 10 implements the function of the transmission unit 103 by the processing in ACT10 and ACT11.

As illustrated in FIG. 6, a federated learning client 20 transmits the inquiry event EVa in ACT21. The inquiry event EVa includes the particular client identification information CID of the federated learning client 20. The federated learning client 20 then proceeds to ACT22. The federated learning client 20 waits for a response in ACT22.

Once the federated learning client 20 receives the response from the federated learning server 10, the federated learning client 20 proceeds to ACT23. The federated learning client 20 determines whether the response is a response (no) event EVb or a response (yes) event EVc in ACT23. If the response is a response (no) event EVb, the federated learning client 20 returns to ACT21. The federated learning client 20 transmits an inquiry event EVa again at regular intervals.

In ACT23, if the response is a response (yes) event EVc, the federated learning client 20 proceeds to ACT24. The federated learning client 20 transmits a program request event EVd to the federated learning server 10 in ACT24. Then, the federated learning client 20 waits to receive the federated learning configuration instruction program 60 in ACT25. Once the federated learning client 20 receives the federated learning configuration instruction program 60, the federated learning client 20 proceeds to ACT26. The federated learning client 20 stores the received federated learning configuration instruction program 60 in ACT26. Then, the federated learning client 20 executes the federated learning configuration instruction program 60 in ACT27. After the above, the federated learning client 20 ends the information processing according to the client-side setup program 50.

As described, the federated learning client 20 periodically transmits the inquiry event EVa to the federated learning server 10 until the federated learning client 20 receives a response (yes) event EVc (ACT21). Once the federated learning client 20 receives the response (yes) event EVc from the federated learning server 10 in response to an inquiry event EVa (YES in ACT23), the federated learning client 20 transmits the program request event EVd to the federated learning server 10 (ACT24). After the federated learning client 20 receives the federated learning configuration instruction program 60 from the federated learning server 10 (YES in ACT25), the federated learning client 20 stores the federated learning configuration instruction program 60 and then executes the program (ACT27). That is, by this processing, the federated learning client 20 is set up as a client in the federated learning system 100. Here, the federated learning client 20 implements the function of the notification unit 201 by the processing in ACT21. The federated learning client 20 implements the function of the reception unit 202 by the processing in ACT25. The federated learning client 20 implements the function of the execution unit 203 by the processing in ACT27.

As described, in the first embodiment, if the federated learning server 10 receives an inquiry event EVa including client identification information CID that has been previously stored in the storage database 13, the federated learning server 10 distributes the federated learning configuration instruction program 60 to the computer that sent inquiry so that computer can be a federated learning client 20 at one of the sites A, B, or C by executing the federated learning configuration instruction program 60. In this manner, a federated learning client 20 is set up as a client in the federated learning system 100.

According to the first embodiment, each of the federated learning clients 20 respectively provided at the sites A, B, and C can be set up as a client in the federated learning system 100 by online processing via the communication network 30. As a result, it is possible to reduce labor and time of the work of setting up a federated learning client 20 at each site, regardless of the number of sites and a physical distance between the sites, and to achieve efficient setup.

In the first embodiment, the federated learning client 20 whose client identification information CID is stored in the storage database 13 can be set up as the client of the federated learning system 100. Therefore, for example, a case may be assumed in which sales prediction models for stores located in a region X and a region Y are separately established using the federated learning system 100.

In such a case, once the sales prediction model for region X is established, the control computer 40 may generate a data file 61 including the client identification information CID for the federated learning clients 20 of the stores located in region X. Similarly, once a sales prediction model for region Y is established, the control computer 40 may generate a data file 61 including the client identification information CID for the federated learning clients 20 of the stores located in region Y. However, when a sales prediction model is established by integrating the separate models for region X and region Y, the control computer 40 may generate a data file 61 including the client identification information CID for the federated learning clients 20 of the stores located in both region X and region Y. As described above, according to the first embodiment, there is an advantage that the construction of the flexible federated learning system 100 can be easily implemented in a short time by using online processing.

### Second Embodiment

Next, a second embodiment of the setup of a federated learning system 100 will be described.

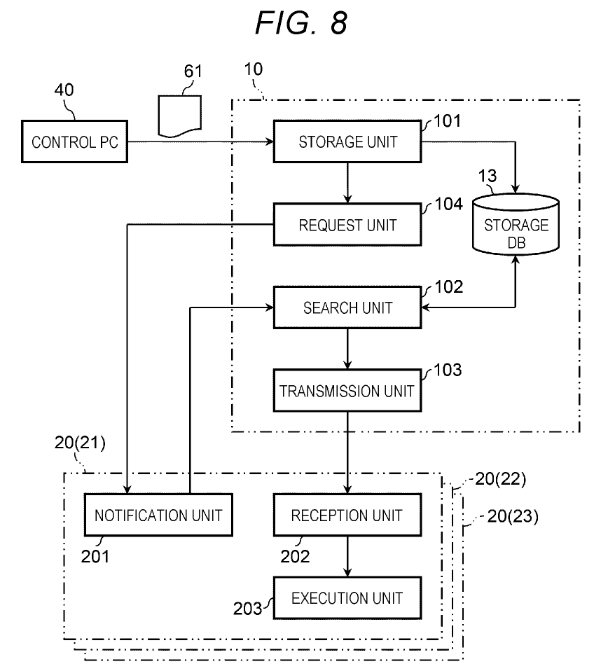

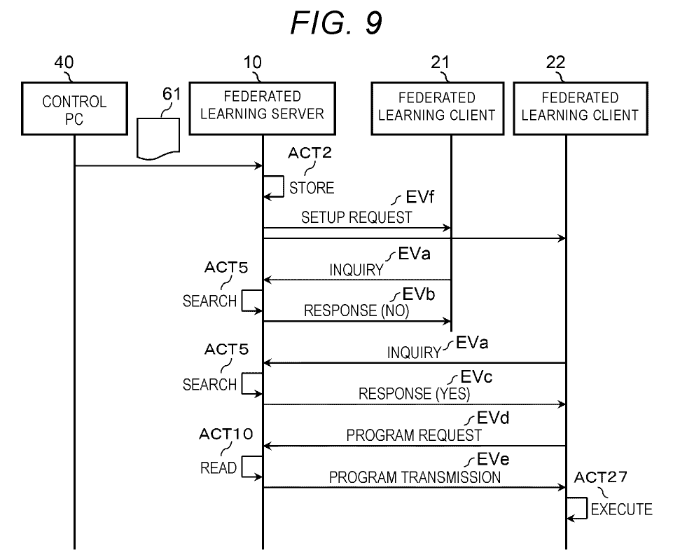

FIG. 8 is a block diagram illustrating a functional configuration of the federated learning server 10 and the federated learning clients 20 in the second embodiment. FIG. 9 is a sequence diagram of data signals exchanged among the control computer 40, the federated learning server 10, and the federated learning clients 20 (the federated learning client 21 and the federated learning client 22 are specifically illustrated in FIG. 9) according to the second embodiment. Differences between the second embodiment and the first embodiment will be described below with reference to FIGS. 8 and 9.

In the second embodiment, the federated learning server 10 includes a server-side setup program. Each federated learning client 20 includes a client-side setup program 50. When the federated learning server 10 receives the data file 61 from the control computer 40, the federated learning server 10 stores, in the storage database 13, the federated learning configuration instruction program 60 and the pieces of client identification information CID in the data file 61.

As illustrated in FIG. 8, the federated learning server 10 provides a function of a request unit 104 in addition to the functions of a storage unit 101, a search unit 102, and a transmission unit 103. The request unit 104 sends a request to a federated learning client 20 to perform the setup after the setup data is stored in the storage database 13. After the information of the data file 61 is stored in the storage database 13 by the storage unit 101, the request unit 104 transmits a setup request event EVf to the federated learning client 20.

The federated learning client 20 receives the setup request event EVf then notifies the federated learning server 10 of its client identification information CID as a function of the notification unit 201. That is, as illustrated in FIG. 9, the federated learning client 21 transmits the inquiry event EVa to the federated learning server 10. The federated learning client 22 also transmits an inquiry event EVa to the federated learning server 10.

The federated learning server 10 searches, as a function of the search unit 102, for the associated client identification information CID in the storage database 13. Here, if the client identification information CID-a of the federated learning client 21 is not stored in the storage database 13, the federated learning server 10 transmits the response (no) event EVb to the federated learning client 21.

If the client identification information CID-b of the federated learning client 22 is stored in the storage database 13, the federated learning server 10 transmits the response (yes) event EVc to the federated learning client 22. The federated learning client 22 receives the response (yes) event EVc then transmits a program request event EVd to the federated learning server 10. In response to the program request event EVd, the federated learning server 10 transmits the program transmission event EVe. Thus, the federated learning configuration instruction program 60 is executed in the federated learning client 22 and the federated learning client 22 is set up as a client in the federated learning system 100. Meanwhile, the federated learning client 21 that received the response (no) event EVb is not set up as a client.

As described above, in the second embodiment, the federated learning client 20 does not transmit an inquiry event EVa until the setup request event EVf is received from the federated learning server 10. The inquiry event EVa is transmitted only once after the setup request event EVf is received. Therefore, as compared with the first embodiment in which the inquiry event EVa is periodically (repeatedly) transmitted, the processing load on the federated learning client 20 can be reduced. In the second embodiment, the setup of the federated learning system 100 can be efficiently performed, and a work load and an operation time can be significantly reduced.

### Third Embodiment

Next, a third embodiment of a setup of a federated learning system 100 will be described.

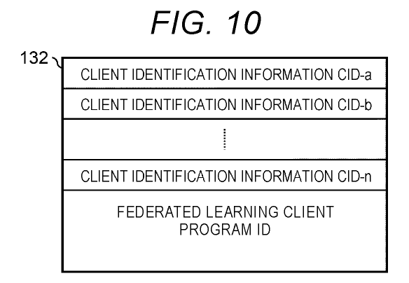

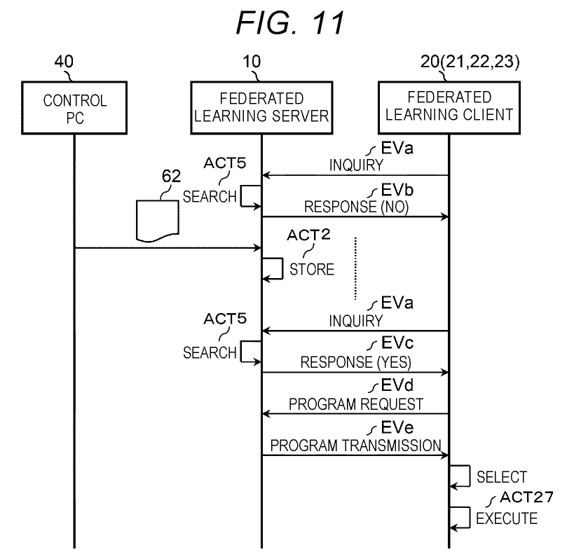

FIG. 10 is an example of data 132 stored in the storage database 13 according to the third embodiment. FIG. 11 is a sequence diagram of data signals exchanged among the control computer 40, the federated learning server 10, and the federated learning client 20 according to the third embodiment. Differences between the third embodiment and the first embodiment will be primarily described below with reference to FIGS. 10 and 11.

As shown in FIG. 10, in the third embodiment, the plurality of pieces of client identification information CID and a program ID of the federated learning configuration instruction program 60 are stored in the storage database 13 as the data 132. The data 132 is stored in a data file 62 (see FIG. 11) created by the control computer 40. The data file 62 can be transmitted to the federated learning server 10 and stored in the storage database 13.

The federated learning configuration instruction program 60 is installed in advance in the federated learning client 20.

In the third embodiment, the federated learning client 20 periodically transmits an inquiry event EVa. The federated learning server 10 receives the inquiry event EVa then searches the storage database 13. If the client identification information CID included in the inquiry event EVa is in the storage database 13, the federated learning server 10 transmits the response (yes) event EVc to the federated learning client 20 that sent the inquiry. When the federated learning server 10 receives a program request event EVd from the federated learning client 20, the federated learning server 10 transmits the program transmission event EVe to the federated learning client 20. In the third embodiment, the program transmission event EVe includes a program ID of the federated learning configuration instruction program 60.

The federated learning client 20 that received the program transmission event EVe selects and executes the federated learning configuration instruction program 60 as specified by the program ID included in the program transmission event EVe. Thus, the federated learning client 20 can be set up as a client of the federated learning system 100.

As described above, in the third embodiment, the program transmission event EVe does not include the federated learning configuration instruction program 60 but rather the program ID of the federated learning configuration instruction program 60 to be used. Therefore, as compared with the first embodiment in which the program transmission event EVe includes the federated learning configuration instruction program 60, the capacity of data communication performed via the communication network 30 to set up a federated learning client 20 can be reduced. In the third embodiment, the setup of the federated learning system 100 can be efficiently performed, and a work load and an operation time can be significantly reduced.

### Fourth Embodiment

Next, a fourth embodiment for setup of the federated learning system 100 will be described.

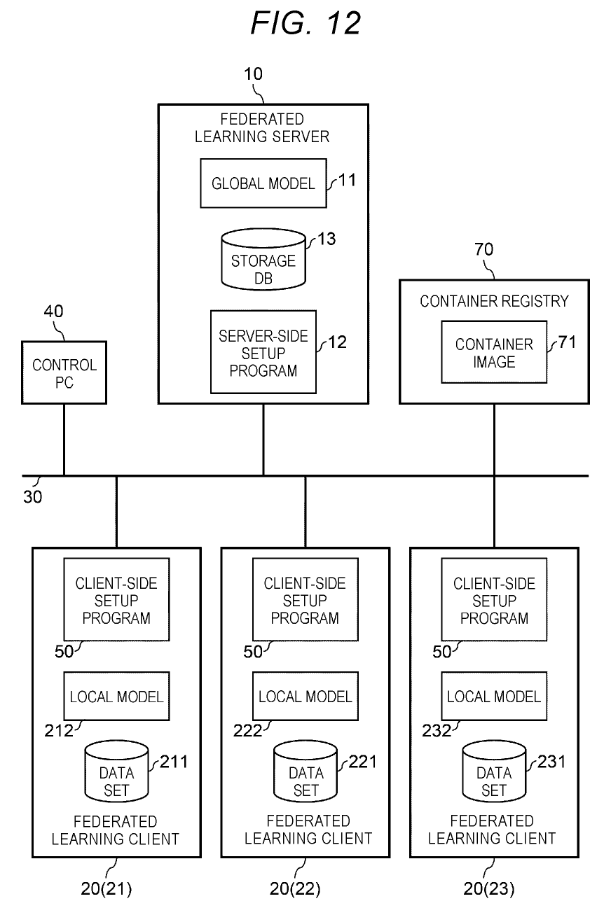

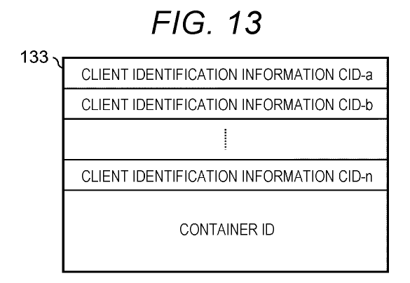

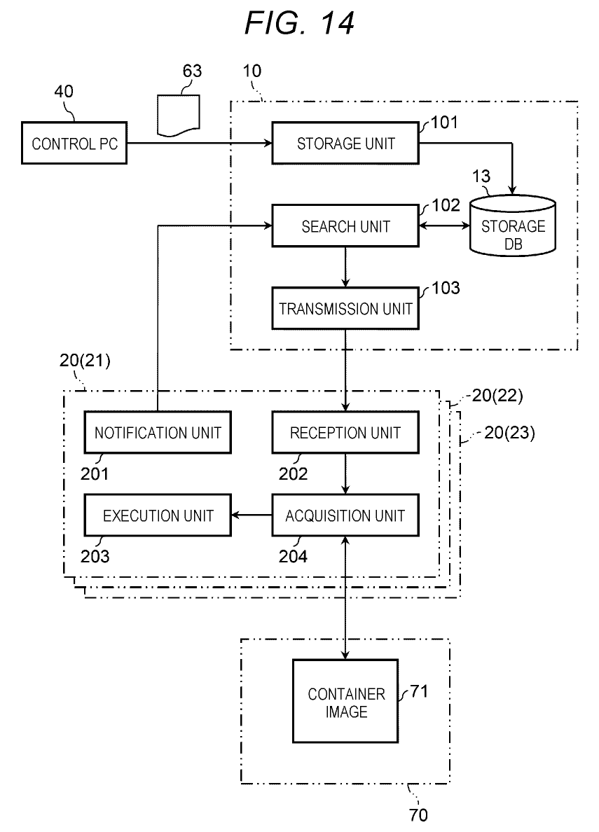

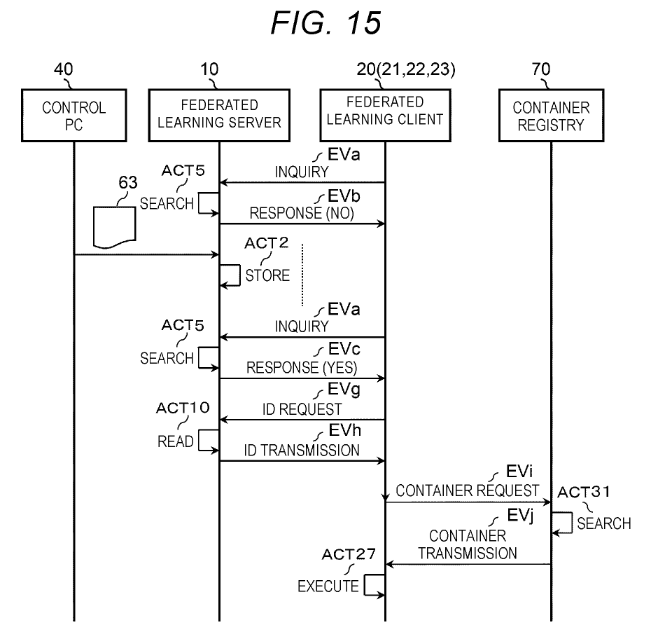

FIG. 12 is a diagram related to the setup of the federated learning system 100 according to the fourth embodiment. FIG. 13 is an example of data 133 stored in the storage database 13 according to the fourth embodiment. FIG. 14 is a block diagram illustrating a functional configuration of the federated learning server 10 and the federated learning clients 20, which is related to the setup of the federated learning system 100 according to the fourth embodiment. FIG. 15 is a sequence diagram of data signals exchanged among the control computer 40, the federated learning server 10, the federated learning client 20, and a container registry 70 according to the fourth embodiment. Differences between the fourth embodiment and the first embodiment will be primarily described below with reference to FIGS. 12 to 15.

As illustrated in FIG. 12, in the fourth embodiment, a container registry 70 is connected to the communication network 30. The container registry 70 manages a container image 71. The container image 71 is a collection of machine learning programs to be respectively executed locally by the federated learning clients 20, a program for calling parameter data (machine learning parameter data) into a federated learning framework (e.g., the federated learning configuration instruction program 60), a library related to these programs, and the like. In the container image 71, a container ID is set as unique identification information.

As shown in FIG. 13, in the fourth embodiment, the plurality of pieces of client identification information CID and the container ID are stored in the storage database 13 as the data 133. The data 133 is stored in a data file 63 (see FIG. 14) created by the control computer 40. The data file 64 is transmitted to the federated learning server 10 and stored in the storage database 13. The container ID is the identification information of the container image 71 stored in the container registry 70.

As illustrated in FIG. 14, in the fourth embodiment, the federated learning server 10 includes the storage unit 101, the search unit 102, and the transmission unit 103. However, the transmission unit 103 transmits the container ID to the federated learning client 20 identified by the client identification information CID stored in the storage database 13.

That is, as shown in FIG. 15, when the federated learning server 10 receives the inquiry event EVa from the federated learning client 20, the federated learning server 10 searches the storage database 13. When the client identification information CID included in the inquiry event EVa is not in the storage database 13, the federated learning server 10 transmits the response (no) event EVb to the federated learning client 20. When the client identification information CID included in the inquiry event EVa is in the storage database 13, the federated learning server 10 transmits the response (yes) event EVc to the federated learning client 20.

The federated learning client 20 receives the response (yes) event EVc then transmits a container ID request event EVg to the federated learning server 10. The federated learning server 10 receives the program request event EVd then transmits a container ID transmission event EVh. The container ID transmission event EVh includes the container ID stored in the storage database 13.

The federated learning client 20 receives the container ID transmission event EVh then performs the functions of an acquisition unit 204. The acquisition unit 204 acquires, from the container registry 70, the container image 71 identified by the identification information of the container image received by the reception unit 202, that is, the container ID. The federated learning client 20 transmits a container request event EVi to the container registry 70 as a function of the acquisition unit 204. The container request event EVi includes the container ID acquired from the container ID transmission event EVh.

The container registry 70 receives the container request event EVi then searches for the container image 71 matching the container ID included in the container request event EVi (ACT31). Then, the container registry 70 transmits a container transmission event EVj including the corresponding container image 71 to the federated learning client 20.

The federated learning client 20 receives the container transmission event EVj then performs the functions of the execution unit 203. That is, the federated learning client 20 downloads and deploys the container image 71. Thus, for the federated learning client 20 whose client ID is stored in the storage database 13, the federated learning configuration instruction program 60 can be executed together with the machine learning program. As a result, the federated learning client 20 is set up as a client of the federated learning system 100.

As described above, in the fourth embodiment, the container image 71 is downloaded and deployed only to a federated learning client 20 whose client ID is stored in the storage database 13. The container image 71 includes not only the federated learning configuration instruction program 60 but also a machine learning program and the like. Therefore, since it is not necessary to install the machine learning program in advance in the federated learning client 20, the setup can be performed more efficiently, and a work load and an operation time can be significantly reduced.

### Other Embodiment

Although certain embodiments in which the setup for constructing the federated learning system 100 can be efficiently performed have been described above, the embodiments are not limited thereto.

For example, in certain embodiments, the federated learning server 10 receives the inquiry event EVa then searches the storage database 13, and when the federated learning server 10 confirms that the client identification information CID included in the inquiry event EVa is in the storage database 13, the federated learning server 10 transmits a response (yes) event EVc to the federated learning client 20 that sent the inquiry. The federated learning client 20 that receives a response (yes) event EVc then transmits the program request event EVd or the container ID request event EVg. The federated learning server 10 receives the program request event EVd or the container ID request event EVg then transmits the program transmission event EVe or the container ID transmission event EVh. The federated learning server 10 may instead go ahead and transmit the program transmission event EVe or the container ID transmission event EVh instead of a response (yes) event EVc. In this way, some of the signal events necessary for the setup of the federated learning client 20 may omitted, so that the processing load of the federated learning server 10 and the federated learning client 20 can be further reduced.

In the second embodiment, if the setup data is stored in the storage database 13, the federated learning server 10 requests the federated learning client 20 to perform the setup. regarding other examples, the federated learning server 10 may itself select a federated learning client 20 specified by a client ID stored in the storage database 13 and request the selected federated learning client 20 perform setup. In this way, a federated learning client 20 whose client ID is not stored in the storage database 13 does not transmit the inquiry event EVa, so that the processing load can be reduced.

In the fourth embodiment, the container registry 70 is provided separately from the federated learning server 10. In other examples, the federated learning server 10 and the container registry 70 may be implemented as one server or the like.

While certain embodiments have been described, these embodiments have been presented by way of example only, and are not intended to limit the scope of the disclosure. Indeed, the novel embodiments described herein may be embodied in a variety of other forms; furthermore, various omissions, substitutions and changes in the form of the embodiments described herein may be made without departing from the spirit of the disclosure. The accompanying claims and their equivalents are intended to cover such forms or modifications as would fall within the scope and spirit of the disclosure.

What is claimed is:

1. A federated learning system, comprising:
a federated learning server storing a client ID database and federated learning client setup information; and
a plurality of federated learning clients communicably connected to the federated learning server, wherein
the federated learning server is configured to:
receive a setup inquiry from a federated learning client in the plurality of federated learning clients,
search the client ID database to confirm a client ID included in the setup inquiry is in the client ID database,
send a setup inquiry response to the federated learning client when the client ID included in the setup inquiry is confirmed as being in the client ID database, and
send the federated learning client setup information to the federated learning client after the client ID included in the setup inquiry is confirmed as being in the client ID database; and
the federated learning client is configured to:
receive the federated learning client setup information from the federated learning server, and
execute a federated learning client setup based on the received federated learning client setup information.

2. The federated learning system according to claim 1, wherein the federated learning client is configured to periodically send the setup inquiry to the federated learning server.

3. The federated learning system according to claim 1, wherein the federated learning client is configured to send the setup inquiry only in response to a request from the federated learning server.

4. The federated learning system according to claim 1, wherein the setup inquiry response to the federated learning client includes the federated learning client setup information.

5. The federated learning system according to claim 1, wherein the federated learning server sends the federated learning client setup information in response to a setup information request from the federated learning client after the federated learning client receives the setup inquiry response.

6. The federated learning system according to claim 1, wherein the federated learning client setup information includes a federated learning configuration instruction program.

7. The federated learning system according to claim 1, wherein
the federated learning client stores a federated learning configuration instruction program before the federated learning client setup information is sent to the federated learning client, and
the federated client setup information includes a program ID permitting the federated learning client to execute the stored federated learning configuration instruction program.

8. The federated learning system according to claim 1, further comprising:
a container registry storing a container image that is a collection of programs to be executed by the plurality of federated learning clients and associated libraries and data files, wherein
the federated client setup information includes a container ID permitting the federated learning client to retrieve the container image from the container registry.

9. The federated learning system according to claim 1, wherein
the federated learning server stores a global model having parameters set based on local model parameters sent from the plurality of federated learning clients, and
each federated learning client respectively stores a local model having local model parameters set according to local model training.

10. A federated learning server for a federated learning system, the server comprising:
a storage unit storing a client ID database, a server-side setup program, and federated learning client setup information;
a communication interface connectable to a plurality of federated learning clients, wherein
the federated learning server executes the server-side setup program to be configured to:
receive, via the communication interface, a setup inquiry from a federated learning client in the plurality of federated learning clients;
search the client ID database in the storage unit to confirm a client ID included in the setup inquiry is in the client ID database;
send, via the communication interface, a setup inquiry response to the federated learning client when the client ID included in the setup inquiry is confirmed as being in the client ID database; and
send, via the communication interface, the federated learning client setup information to the federated learning client after the client ID included in the setup inquiry is confirmed as being in the client ID database.

11. The federated learning server according to claim 10, wherein the federated learning client is configured to periodically send the setup inquiry to the federated learning server.

12. The federated learning server according to claim 10, wherein the federated learning server is further configured by the server-side setup program to send, via the communication interface, a request to the federated learning client.

13. The federated learning server according to claim 10, wherein the setup inquiry response to the federated learning client includes the federated learning client setup information.

14. The federated learning server according to claim 10, wherein the federated learning server sends, via the communication interface, the federated learning client setup information in response to a setup information request from the federated learning client after the federated learning client receives the setup inquiry response.

15. The federated learning server according to claim 10, wherein the federated learning client setup information includes a federated learning configuration instruction program.

16. The federated learning server according to claim 10, wherein
the federated learning client stores a federated learning configuration instruction program before the federated learning client setup information is sent to the federated learning client, and
the federated client setup information includes a program ID permitting the federated learning client to execute the stored federated learning configuration instruction program.

17. The federated learning server according to claim 10, wherein
the federated client setup information includes a container ID permitting the federated learning client to retrieve a container image from an container registry,
the container image being a collection of programs to be executed by the federated learning client and associated libraries and data files.

18. The federated learning server according to claim 10, wherein the storage unit stores a global model having parameters set based on local model parameters sent from the plurality of federated learning clients.

19. A federated learning client for a federated learning system including a federated learning server according to claim 10, wherein the federated learning client is configured to:
receive the federated learning client setup information from the federated learning server, and
execute a federated learning client setup based on the received federated learning client setup information.

20. The federated learning client according to claim 19, wherein the federated learning client is configured to periodically send the setup inquiry to the federated learning server.
